(19) United States
(12) Patent Application Publication
(10) Pub. No.: US 2012/0243019 A1
(43) Pub. Date: Sep. 27, 2012

(54) SHEET FEEDING APPARATUS AND IMAGE FORMING APPARATUS

(75) Inventor: Kakeru Takahashi, Toride-shi (JP)

(73) Assignee: CANON KABUSHIKI KAISHA, Tokyo (JP)

(21) Appl. No.: 13/420,762

(22) Filed: Mar. 15, 2012

(30) Foreign Application Priority Data
Mar. 24, 2011 (JP) 2011-065998

(51) Int. Cl. G06F 15/02; B65H 3/06

(52) U.S. Cl. 358/1.13; 271/110

(57) ABSTRACT

The sheet feeding apparatus is controlled so as to temporarily stop driving of a separation part that feeds sheets from a sheet container while separating the sheets one by one by means of a feeding roller and a retard roller, after passage of a predetermined period of time from the sheets being fed out. Then, when the temporarily-stopped driving of the separation part is resumed, the detection part detects whether or not a sheet exists in a separation nip part formed by the feeding roller and the retard roller, and if the detection part determines that a sheet exists, a second motor makes the retard roller temporarily rotate in a sheet feeding direction.

### BACKGROUND OF THE INVENTION

1. Field of the Invention

The present invention relates to a sheet feeding apparatus and an image forming apparatus, and specifically relates to a configuration of a separation part that separates sheets one by one using a retard roller.

2. Description of the Related Art

Conventionally, image forming apparatuses such as printers, copiers and facsimile machines include a sheet feeding apparatus that separates sheets set in a cassette one by one using a sheet feed roller and feeds the respective sheets to an image forming part. When sheets are fed, a sheet multi-feed, i.e., simultaneous feeding of two or more sheets, may occur. Therefore, in order to prevent sheet multi-feeds, conventional sheet feeding apparatuses include a separation part that separates sheets one by one.

Examples of such separation part include one using a retard roller separating system, which includes a feeding roller provided downstream of the sheet feed roller in a sheet feeding direction, the feeding roller rotating in a direction in which the sheet feed roller rotates, in synchronization with the sheet feed roller, and a retard roller that is in pressure-contact with the feeding roller across a sheet passageway. Here, the retard roller rotates in a direction opposite to the sheet feeding direction, at a constant torque via a torque limiter, and is also rotatable in association with the feeding roller.

Next, with reference to FIGS. 12A to 12D and 13A to 13C, a sheet feeding operation performed by a sheet feeding apparatus including such separation part using the retard roller separating system will be described. In FIGS. 12A to 12D and 13A to 13C, the sheet feeding apparatus includes a pickup roller 201, which is a sheet feed roller, a feeding roller 202 and a retard roller 203. The sheet feeding apparatus also includes pull-off rollers 204 that pull off each of sheets S separated one by one by the feeding roller 202 and the retard roller 203, and transport rollers 301 that transport each of the sheets S pulled off by the pull-off rollers 204.

FIG. 12A is a diagram illustrating a state of the pickup roller 201, etc., before start of a sheet feeding operation. FIG. 12B illustrates motion of the pickup roller 201, etc., immediately after start of driving of a non-illustrated sheet feed motor as a result of being turned on. In this case, the retard roller 203 receives a driving force from the feeding roller 202 and rotates accompanying the feeding roller in a sheet feeding direction.

FIG. 12C illustrates motion of the pickup roller 201, etc., immediately after a leading edge of an uppermost sheet Sa fed out from the pickup roller 201 passing through a nip part formed by the feeding roller 202 and the retard roller 203. FIG. 12D illustrates motion of the pickup roller 201, etc., immediately after the leading edge of the uppermost sheet Sa being transported to the pull-off rollers 204 by the feeding roller 202. As illustrated in FIGS. 12B to 12D, the retard roller 203 rotates in the sheet feeding direction in association with the feeding roller 202 as a result of receiving the driving force of the feeding roller 202 directly or via the sheet Sa.

FIG. 13A is a diagram illustrating a state of the pickup roller 201, etc., when the leading edge of the sheet has passed through the pull-off rollers 204. Here, a non-illustrated pull-off sensor is arranged in the vicinity of the pull-off rollers 204, and upon the pull-off sensor detecting the leading edge of the sheet Sa, feeding of the sheet Sa is temporarily stopped until a predetermined period of time has passed from the start of the feeding. As a result of the temporary stop of the feeding of the sheet Sa as described above, variation in position of the leading edge of the sheet Sa at the time of starting a sheet feeding operation is corrected. Hereinafter, an operation to temporarily stop feeding of a sheet Sa to correct variation in position of a leading edge of a sheet Sa at the time of starting a sheet feeding operation as described above is referred to as “preregistration halt”.

Upon passage of a predetermined period of time after the preregistration halt, as illustrated in FIG. 13B, the pickup roller 201, etc., resumes rotating. Consequently, the sheet Sa reaches the transport rollers 301, and subsequently, as illustrated in FIG. 13C, is transported to a non-illustrated image forming part by the transport rollers 301.

For the retard roller 203 included in such separation part using the retard roller separating system, a roller including sponge having a high wear resistance and a low surface friction coefficient, such as a urethane sponge roller, may be used. Here, when the pickup roller 201, etc., resume rotating after the preregistration halt, the retard roller 203 receives a driving force from the feeding roller 202 via the sheet Sa. However, where a urethane sponge roller is used as the retard roller 203, when the retard roller 203 receives a driving force via the sheet Sa as described above, the torque of the retard roller cannot exceed a rotation torque provided by the non-illustrated torque limiter. Thus, although the sheet Sa is transported along a peripheral surface of the retard roller 203 as illustrated in FIG. 13B, the retard roller 203 does not rotate as a result of slipping and remains halted.

Furthermore, as illustrated in FIG. 13C, when the sheet Sa is transported by the transport rollers 301, the sheet feed motor is off and the driving force is not transmitted to the pickup roller 201, the feeding roller 202 and the retard roller 203. In such a case where the driving force is not transmitted, the feeding roller 202 is made to rotate accompanying the transported sheet Sa by means of a non-illustrated unidirectional clutch. However, even if the feeding roller 202 rotates accompanying the sheet Sa as described above, the retard roller 203 is made to slip and remain halted by the non-illustrated torque limiter as in the state illustrated in FIG. 13B.

In other words, where an urethane sponge roller is used as the retard roller 203, if the driving is resumed in a state in which the sheet Sa is nipped between the feeding roller 202 and the retard roller 203 under the conveyance of the sheet, a phenomenon in which the retard roller 203 halts occurs. When the retard roller 203 halts, time of pressure application by the retard roller 203 at a preregistration halt position becomes longer compared to the portions around the retard roller 203, resulting in variation of portions subjected to and not subjected to pressure application around the retard roller 203.

The aforementioned retard roller halting phenomenon may occur from the initial period of use depending on the type of the sheet. In this case, in the initial period of use, the preregistration halt position of the retard roller 203 is not determined; however, after passage of around ten thousand of sheets, the preregistration halt position of the retard roller 203 is limited to a particular position due to the effect of variation in pressure-application time from the initial period. Consequently, time of pressure application at the particular position is very long compared to the surrounding part, resulting in generation of a local recession of the sponge at the particular position.

Here, such local recession is generated, the rotation resistance is increased and the driving force received from the feeding roller is reduced, and eventually, a failure in rotation of the retard roller accompanying the feeding roller occurs at the particular position. Then, when a failure in accompanying rotation of the retard roller occurs, the sheet is prevented from entering the nip part between the feeding roller and the retard roller, resulting in the sheet being jammed. Furthermore, the retard roller may reach the end of its usefulness after passage of a number of sheets that is around one-tenth of its proper durability.

Therefore, conventionally, driving methods preventing sheet jamming due to failure in accompanying rotation of a retard roller have been proposed. For example, Japanese Patent Application Laid-Open No. 562-218342 proposes a method in which a feeding roller and a retard roller rotate in a same direction and upon detection of a sheet by a detection member, the retard roller is controlled to rotate a direction opposite to that direction. Also, Japanese Patent Application Laid-Open No. H01-313229 proposes a driving method in which a feeding roller is driven to rotate forward, and after passage of a leading edge of a sheet through the feeding roller, a retard roller is driven to rotate reversely.

However, in such conventional sheet feeding apparatuses and image forming apparatuses including the same, when driving is halted for a predetermined period of time due to a preregistration halt, a local recession is generated in the sponge. Furthermore, in addition to sheet feeding jamming due to failure in accompanying rotation of a retard roller, the local recession disturbs reverse rotation of the retard roller when separating two or more sheets, which may cause a sheet multi-feed.

### SUMMARY OF THE INVENTION

The present invention has been made in view of such circumstances, and an object of the present invention is to provide a sheet feeding apparatus and an image forming apparatus that can prevent generation of a local recession.

A purpose of the present invention is to provide a sheet feeding apparatus including a feeding roller that feeds a sheet from a sheet container, a retard roller that is in pressure-contact with the feeding roller, is provided so as to be rotatable in a direction opposite to a sheet feeding direction, and is capable of rotation following the feeding roller a detection part that detects whether or not a sheet exists in a separation nip part formed by the feeding roller and the retard roller, a rotation direction switching part that temporarily rotates the retard roller in the sheet feeding direction and a control part that temporarily stops driving of the feeding roller after passage of a predetermined period of time from the sheet being fed out, and when the temporarily-stopped driving of the feeding roller is resumed, if the detection part determines that a sheet exists in the separation nip part, makes the rotation direction switching part temporarily rotate the retard roller in the sheet feeding direction.

Another purpose of the present invention is to provide an image forming apparatus including a feeding roller that feeds a sheet from a sheet container, a retard roller that is in pressure-contact with the feeding roller, is provided so as to be rotatable in a direction opposite to a sheet feeding direction in which the sheet is fed out from the sheet container, and is rotatable following the feeding roller, a detection part that detects whether or not a sheet exists in a separation nip part formed by the feeding roller and the retard roller, a rotation direction switching part that temporarily rotates the retard roller in the sheet feeding direction, a control part that temporarily stops driving of the feeding roller after passage of a predetermined period of time from the sheet being fed out, and when the temporarily-stopped driving of the feeding roller is resumed, if the detection part determines that a sheet exists in the separation nip part, makes the rotation direction switching part temporarily rotate the retard roller in the sheet feeding direction, and an image forming part that forms an image on a sheet separated and fed by the feeding roller and the retard roller.

A further purpose of the present invention will become apparent from the following description of exemplary embodiments with reference to the attached drawings.

### BRIEF DESCRIPTION OF THE DRAWINGS

FIG. 1 is a diagram illustrating a configuration of a copier, which is an example of an image forming apparatus including a sheet feeding apparatus according to a first embodiment of the present invention.

FIG. 2 is a diagram illustrating a configuration of a sheet feeding part, which is an example of a sheet feeding apparatus provided in the copier.

FIG. 3 is a diagram illustrating comparison between a rolling resistance force during start-up of a retard roller provided in a sheet feeding part in a sheet cassette, which is an example of the sheet feeding apparatus, and a rolling resistance force during rotation of the same.

FIG. 4 is a diagram illustrating a drive system in the sheet feeding part.

FIG. 5 is a block diagram of control of the sheet feeding part.

FIG. 6 is a flowchart illustrating sheet separating control in the sheet feeding part.

FIGS. 7A, 7B and 7C are diagrams illustrating a sheet feeding operation performed by the sheet feeding part.

FIG. 8 is a diagram illustrating a drive system in a sheet feeding apparatus according to a second embodiment of the present invention.

FIGS. 9A and 9B are diagrams each illustrating an operation of a planetary gear clutch provided in the sheet feeding apparatus.

FIG. 10 is a block diagram of control of the sheet feeding apparatus.

FIG. 11 is a flowchart illustrating sheet separating control in the sheet feeding apparatus.

FIGS. 12A, 12B, 12C and 12D are first diagrams illustrating a sheet feeding operation performed by a conventional sheet feeding apparatus.

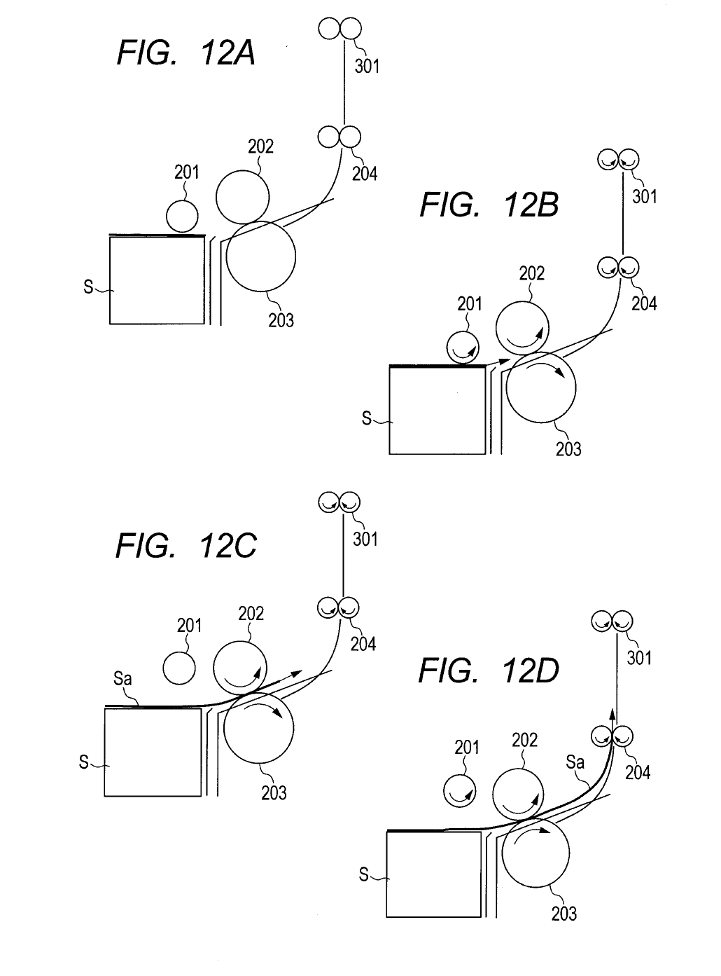

FIGS. 13A, 13B and 13C are second diagrams illustrating the sheet feeding operation performed by the conventional sheet feeding apparatus.

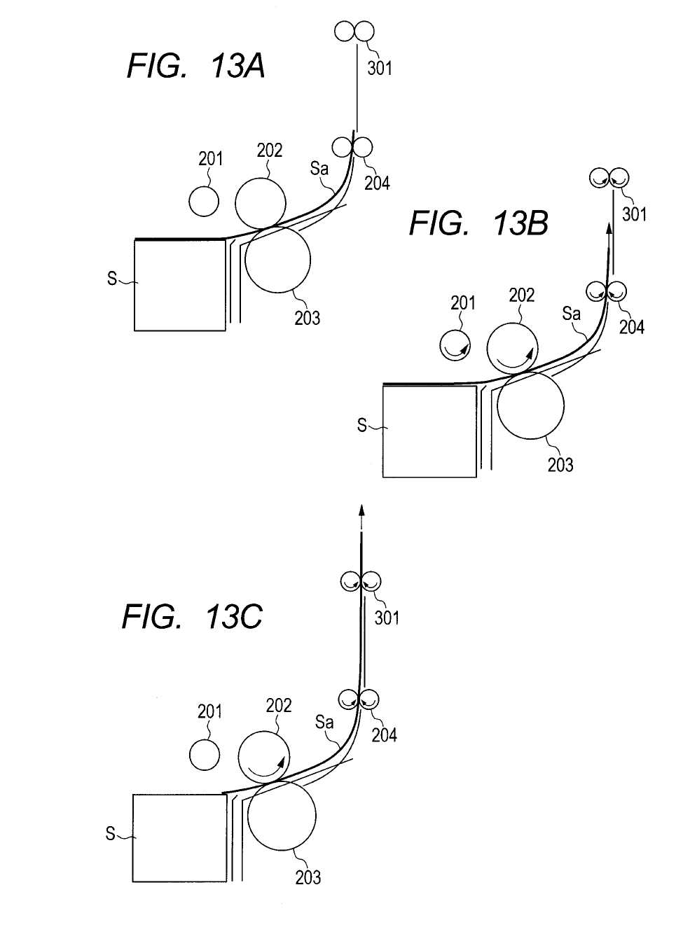

### DESCRIPTION OF THE EMBODIMENTS

Preferred embodiments of the present invention will now be described in detail in accordance with the accompanying drawings.

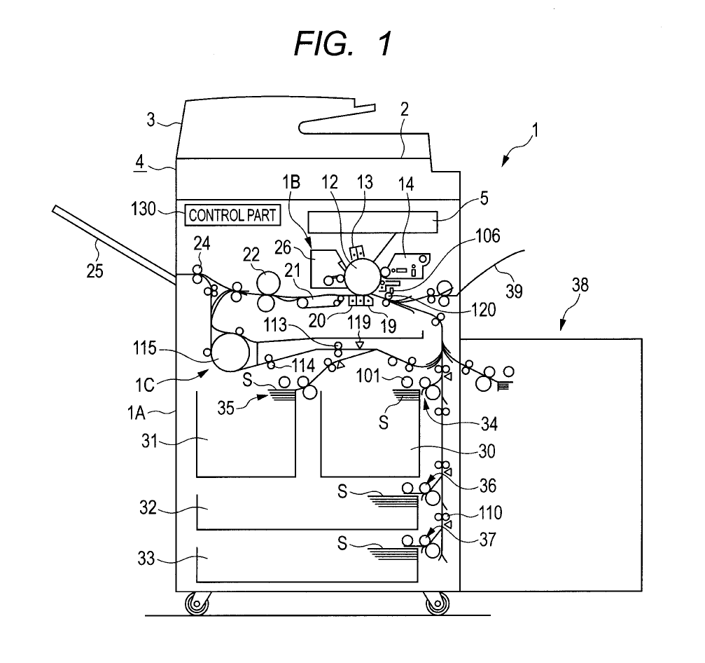

Embodiments of the present invention will be described below with reference to the drawings. FIG. 1 is a diagram illustrating a configuration of a copier, which is an image forming apparatus including a sheet feeding apparatus according to a first embodiment of the present invention.

In FIG. 1, the image forming apparatus includes a copier 1 including a copier body 1A. The copier body 1A includes, e.g., an image reading part 4, an image forming part 1B that forms an image on a sheet, a duplex reverse apparatus 1C, and a glass platen 2. On an upper surface of the copier body 1A, an original document feeding apparatus 3 that feeds an original document onto the glass platen 2 is provided, and on a side of the copier body 1A, a sheet feed deck 38 in which a large amount of sheets are stored. Furthermore, at a side portion of the copier body 1A, a manual sheet feed tray 39 is provided.

The image forming part 1B includes, e.g., a cylindrical photosensitive drum 12, a charge device 13, a developing unit 14, a cleaner (cleaning apparatus) 26, and furthermore, e.g., a fuser part 22 and an output roller pair 24 are arranged downstream of the image forming part 1B. The copier body 1A also includes a control part 130 that controls an image forming operation, and a sheet separating operation performed by a separation part, which will be described later.

Next, an image forming operation performed by the copier 1 configured as described above will be described. Upon an image forming signal being output from the control part 130, first, an original document is mounted on the glass platen 2 by the original document feeding apparatus 3, and an image on the original document is read by the image reading part 4, and the read digital data is input to exposure unit 5. Then, light corresponding to the digital data is applied to the photosensitive drum 12 by the exposure unit 5. Here, a surface of the photosensitive drum 12 is uniformly charged by the charge device 13, and as a result of application of the light, an electrostatic latent image is formed on the surface of the photosensitive drum, and the electrostatic latent image is developed by the developing unit 14, thereby a toner image being formed on the surface of the photosensitive drum.

Meanwhile, upon a sheet feed signal being output from the control part 130, first, a sheet S loaded in any of decks 30 and 31 and sheet cassettes 32 and 33 included in the copier body 1A is transported to registration rollers 120 by a corresponding one of, e.g., deck sheet feeding parts 34 and 35 and sheet feeding parts 36 and 37. Alternatively, a sheet is transported to the registration rollers 120 from the sheet feed deck 38 or the manual sheet feed tray 39.

Next, the sheet S is transported to a transfer part 20 including a transfer charge device 19 at a timing at which a leading edge of the sheet and a leading edge of the toner image on the photosensitive drum 12 are aligned with each other by the registration rollers 120. Then, in the transfer part 20, a transfer bias is applied to the sheet S by the transfer charge device 19, thereby the toner image on the photosensitive drum 12 being transferred onto the sheet.

Next, the sheet S with the toner image transferred thereon is transferred to the fuser part 22 by a transport part 21, and then in the fuser part 22, the toner image is heat-fused onto the sheet. Here, foreign substances, such as remaining toner, attached on the photosensitive drum 12 without being transferred to the sheet are scraped off by a blade of the cleaner 26, and as a result, the surface of the photosensitive drum 12 becomes clear and thus, can be ready for next image formation.

Subsequently, the sheet with the toner image fused thereon is output toward an output tray 25 by the output rollers 24. Where an image is formed on a back surface of the sheet, the sheet with the toner image fused thereon is transported to the duplex reverse apparatus 1C by means of switching of a non-illustrated switching member, and transported to the image forming part 1B again, and an image is formed on the back surface.

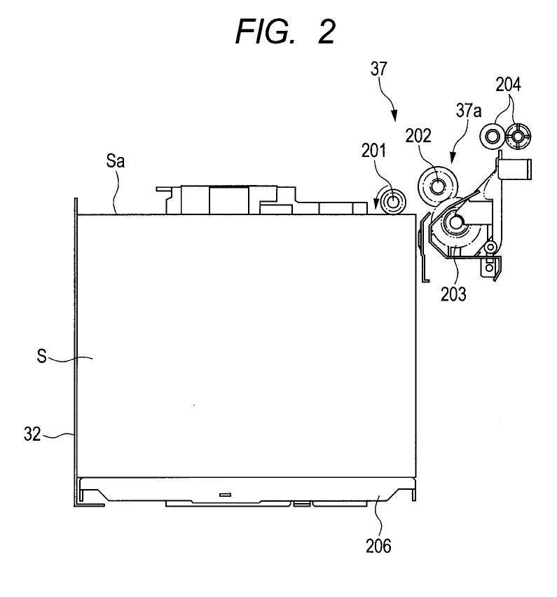

FIG. 2 is a diagram illustrating a configuration of the sheet feeding part 37, which is an example of a sheet feeding apparatus that feeds a sheet stored in the sheet cassette 32. The sheet feeding part 37 includes a pickup roller (sheet feed roller) 201 arranged above the sheet cassette 32, and a feeding roller 202 arranged downstream in a sheet feeding direction of the pickup roller 201. The sheet feeding part 37 also includes a retard roller 203 that is in pressure-contact with the feeding roller 202, and separate sheets one by one by means of a nip part formed jointly with the feeding roller 202. The feeding roller 202 and the retard roller 203 are included in a separation part 37a. In the sheet cassette 32, a lifter 206 is arranged in such a manner that the lifter 206 can freely ascend/descend, and recording sheets S are loaded on the lifter 206.

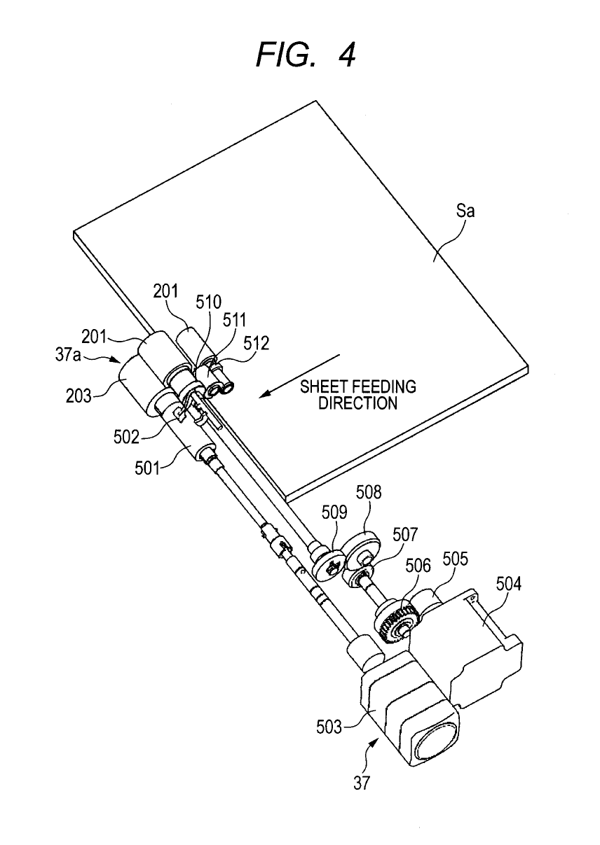

Here, the retard roller 203 is driven by the second motor 503 illustrated in FIG. 4, which will be described later, and receives a driving force to rotate in a direction opposite to the sheet feeding direction at a constant torque via a torque limiter. In other words, the retard roller 203 can rotate in both the sheet feeding direction, and the direction opposite to the sheet feeding direction, i.e., a direction in which a sheet is returned to the sheet cassette side (hereinafter referred to as the “sheet return direction”). Then, if one sheet or no sheet exists in the nip part formed jointly with the feeding roller 202, the retard roller 203 can rotate in association with the sheet or the feeding roller 202 by means of the torque limiter (i.e., can rotate following the sheet or the feeding roller 202). The pull-off rollers 204 pull off each of sheets S separated one by one by the feeding roller 202 and the retard roller 203.

The pickup roller 201 is rotatably supported at a distal end of a non-illustrated arm that is pivotable with reference to a shaft that drives the feeding roller 202, and is connected to the feeding roller 202 via the train of gears illustrated in FIG. 4, which will be described later, and is driven to rotate in synchronization with the feeding roller 202. Also, the pickup roller 201 is configured so that the pickup roller 201 is separatably brought into contact with an uppermost sheet Sa stored in the sheet cassette 32, at a predetermined pressure by non-illustrated ascending/descending unit.

Although the pickup roller 201 configured as described above is normally spaced from the uppermost sheet Sa, upon start of a sheet feeding operation, the pickup roller 201 is brought into pressure-contact with the topmost sheet Sa at a predetermined timing, and subsequently, starts rotating counterclockwise. Consequently, the uppermost sheet Sa is fed out, and the sheets Sa fed out as described above are transported to the feeding roller 202 rotating in synchronization with the pickup roller 201 and the retard roller 203 rotating accompanying the feeding roller 202, and are separated one by one.

Next, each of the sheets Sa separated one by one by the separation part 37a formed by the feeding roller 202 and the retard roller 203 is pulled off by the pull-off rollers 204. After the sheet Sa is pulled off by the pull-off rollers 204 as described above, the sheet Sa is halted until a predetermined period of time has passed from the start of the sheet feeding operation. In other words, the sheet Sa is subjected to a preregistration halt. Then, after passage of the predetermined period of time, the pull-off rollers 204 resume rotating, and consequently, the sheet Sa is subsequently transported to be subjected to registration, transfer and fusing in this order, whereby a toner image is fused to the sheet Sa. In the present embodiment, a non-illustrated sheet feeding apparatus provided in each of the deck sheet feeding parts 34 and 35, the sheet feeding part 36, the sheet feed deck 38 includes a separation part having a configuration similar to that of the sheet feeding part 37 for the sheet cassette 32.

In the present embodiment, an urethane sponge roller is used as the retard roller 203. Here, when a urethane sponge roller is brought into pressure-contact with the feeding roller 202, the urethane sponge roller is crushed more during rotation than during rest. In other words, when a urethane sponge roller is brought into contact with the feeding roller 202 in a resting state, the urethane sponge roller has a larger dent than that during rotation. Thus, when the retard roller 203 starts rotating, in order to rotate the retard roller 203 that is in pressure-contact with the feeding roller 202, it is necessary to let the retard roller 203 get out of the dented state, and thus, a driving force larger than that for maintaining a rotating state is necessary to drive the retard roller 203.

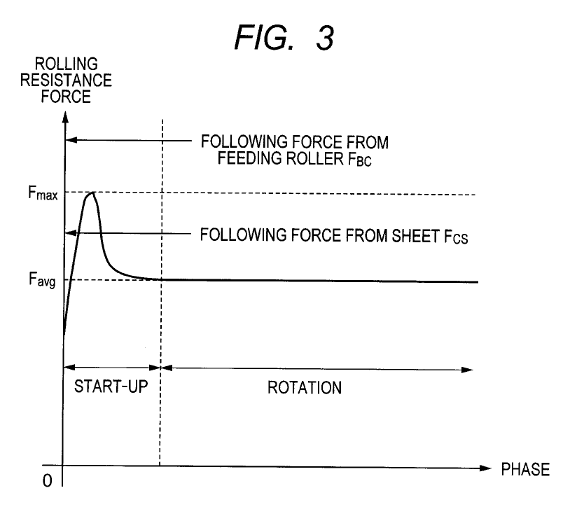

FIG. 3 illustrates comparison between a rolling resistance force during start-up of a retard roller (urethane sponge roller) and a rolling resistance force during rotation of the same when the retard roller is rotated in the sheet feeding direction. In FIG. 3, Fₘₐₓ is a rolling resistance force during start-up of the retard roller, and F_{avg} is a rolling resistance force of the retard roller in a rotating state.

Also, F_{BC} is a following force provided from the feeding roller to the retard roller by means of a static frictional force between the feeding roller and the retard roller, F_{CS} is a following force provided from the feeding roller to the retard roller via a sheet by means of a static frictional force between the sheet and the retard roller. Then, there is a relationship in magnitude among Fₘₐₓ, F_{avg}, F_{BC} and F_{CS} as indicated below so that sheets can be separated one by one.

F_{BC}>Fₘₐₓ>F_{CS}>F_{avg}

From the relationship, if the driving is started in a state in which no sheet exists in a nip part formed by the feeding roller and the retard roller (hereinafter referred to as “separation nip part”), a following force F_{BC} that is larger than a maximum value Fₘₐₓ of the rolling resistance force during start-up is provided to the retard roller by the feeding roller. Consequently, the retard roller can rotate accompanying the feeding roller in the sheet feeding direction.

Meanwhile, if the driving is started in a state in which a sheet exists in the separation nip part, the following force F_{CS} is provided by the sheet to the retard roller. Here, the following force F_{CS} is smaller than the maximum value Fₘₐₓ of the rolling resistance force during start-up, and thus, the retard roller cannot rotate. Consequently, as already described, if the driving is started in a state in which a sheet exists in the separation nip part after a preregistration halt, the retard roller does not rotate and the sheet passes by a surface of the retard roller.

The rolling resistance force F_{avg} in a rotating state is smaller than the following force F_{CS}. Thus, even if a sheet enters the separation nip part when the retard roller is in a rotating state, the retard roller can rotate accompanying the sheet in the sheet feeding direction. In other words, where the driving is started in a state in which no sheet exists in the separation nip part, even if a sheet enters the separation nip part afterward, the retard roller can rotate accompanying the sheet in the sheet feeding direction by the following force F_{CS}from the sheet.

According to the above, even where driving is started in a state in which a sheet exists in the separation nip part, if the retard roller is temporarily made to enter a rotating state, the retard roller can be rotated together with the sheet. Therefore, in the present embodiment, after a preregistration halt, the retard roller 203 is rotated in the sheet feeding direction for a predetermined period of time to make the retard roller 203 enter a rotating state.

FIG. 4 is a diagram illustrating a driving system in the sheet feeding part 37. As illustrated in FIG. 4, the pickup roller 201 and the feeding roller 202 are connected by gears 510 to 512, and upon receipt of a driving force from the first motor 504 via gears 505 to 509, are driven to rotate in synchronization with each other. The retard roller 203 is directly driven by the second motor 503. The second motor 503 is a pulse motor that can rotate forward/reversely.

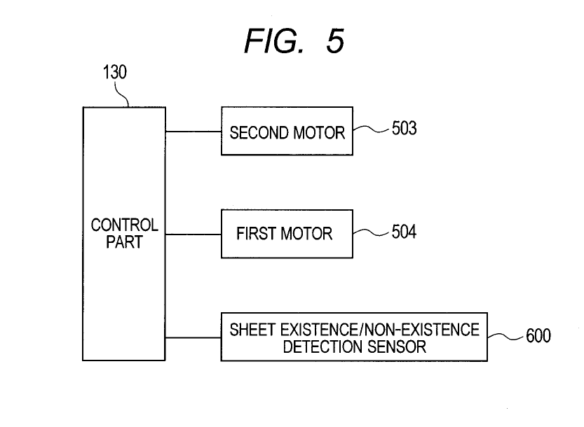

Furthermore, the driving system includes a sheet existence/non-resistance detection sensor 600, which is illustrated in FIG. 5 and will be described later. The sheet existence/non-resistance detection sensor 600 is included in a detection part that detects whether or not a sheet exists in the separation nip part and includes a sensor flag 502 and a non-illustrated photo-interrupter. If a sheet exists in the separation nip part, the sensor flag 502 interrupts the photo-interrupter, thereby the sheet existence/non-resistance detection sensor 600 detecting the existence of the sheet. The detection part includes the sheet existence/non-resistance detection sensor 600 and a control part 130 (which will be described later) that determines whether or not a sheet exists based on detection performed by the sheet existence/non-resistance detection sensor 600.

FIG. 5 is a block diagram of control of the sheet feeding part 37. As illustrated in FIG. 5, the first motor 504, the second motor 503, which is a rotation direction switching part, and the sheet existence/non-resistance detection sensor 600 are connected to the control part 130. Then, when feeding of sheets is resumed after a preregistration halt, upon a signal representing that a sheet exists in the separation nip part being input from the sheet existence/non-resistance detection sensor 600, the control part 130 performs control to reversely rotate the second motor 503 for a predetermined period of time from a predetermined timing. In other words, if the driving is started in a state in which a sheet exists in the separation nip part, the control part 130 performs control to rotate the retard roller 203 in the sheet feeding direction for a predetermine period of time by the second motor 503 and subsequently drive the retard roller 203 to rotate in the sheet return direction.

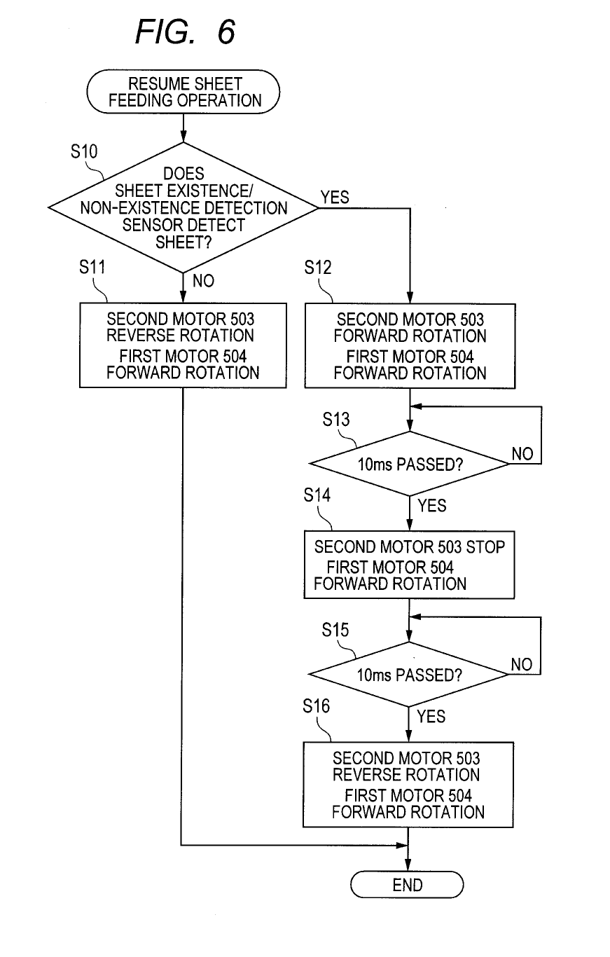

Next, sheet separation control in the sheet feeding part 37 will be described using the flowchart illustrated in FIG. 6. The second motor 503 has a sequence in which the second motor 503 rotates in synchronization with the first motor 504. Here, it is assumed that a direction of rotation of the second motor 503 when the retard roller 203 is rotated in the sheet feeding direction is forward rotation and a direction of rotation of the second motor 503 when the retard roller 203 is rotated in the sheet return direction is reverse rotation. Also, it is assumed that a direction of rotation of the first motor 504 when the pickup roller 201 and the feeding roller 202 are rotated in the sheet feeding direction is forward rotation.

Upon a sheet feeding operation being resumed after passage of a predetermined period of time from a preregistration halt, the control part 130 determines whether or not a sheet exists in the separation nip part, based on detection by the sheet existence/non-resistance detection sensor 600 (S10). Then, if the sheet existence/non-resistance detection sensor 600 detects no sheet (N in S10), the first motor 504 is rotated forward, and the second motor 503 is rotated reversely (S11) to drive the retard roller 203 to rotate in the sheet return direction. A time for starting up the second motor 503 in this case is the same as that of the first motor 504. Here, even where the second motor 503 is rotated reversely, the retard roller 203 rotates accompanying the feeding roller 202. Then, when sheets are transported to the separation nip part afterward as a result of the first motor 504 being rotated forward and the retard roller 203 being rotated accompanying the feeding roller 202 as described above, the sheets are separated one by one.

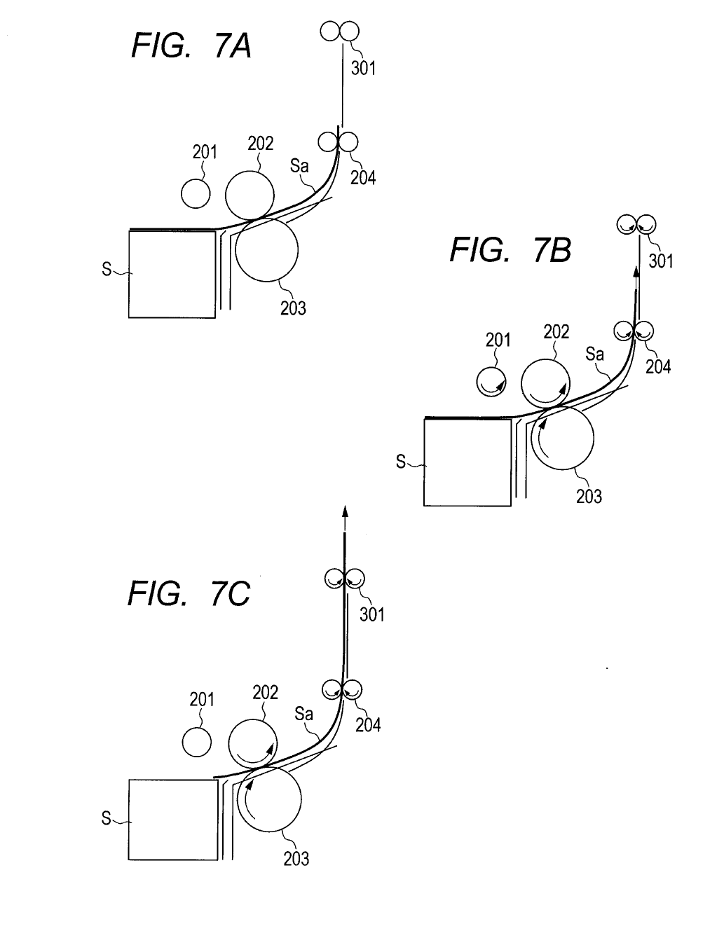

Furthermore, as illustrated in FIG. 7A, if a sheet Sa exists in the separation nip part, the sheet existence/non-resistance detection sensor 600 detects the sheet (Y in S10), the control part 130 determines that a sheet exists in the separation nip part. Then, in this case, as illustrated in FIG. 7B, the first motor 504 is rotated forward while the second motor 503 is rotated forward for a predetermined period of time, for example, 10 ms to drive the retard roller 203 to rotate in the sheet feeding direction (S12). Consequently, the retard roller 203 is rotated in the sheet feeding direction, and the sheet existing in the separation nip part passes through the separation nip part. Then, as a result of the retard roller 203 being rotated in the sheet feeding direction, the following force F_{CS} provided to the retard roller 203 via the sheet is larger than the rolling resistance force F_{avg} of the retard roller 203.

Next, subsequently, after passage of 10 ms (Y in S13), the first motor 504 is rotated forward while the speed of the second motor 503 is reduced to halt the second motor 503 (S14). Here, even though the second motor 503 is halted as described above, the following force F_{CS} is larger than the rolling resistance force F_{avg}, and thus, the accompanying rotation of the retard roller 203 is maintained. Furthermore, after passage of 10 ms from the halt of the second motor 503 (Y in S15), the first motor 504 is rotated forward while the second motor 503 is rotated reversely (S16).

Here, even when the second motor 503 is rotated reversely, the retard roller 203 is rotated in the sheet feeding direction as described above, and thus, the following force F_{CS} is larger than the rolling resistance force F_{avg}. Consequently, as illustrated in FIG. 7C, the retard roller 203 rotates accompanying the feeding roller 202. Then, when sheets are transported to the separation nip part afterward as result of the first motor 504 being rotated forward while the retard roller 203 being rotated accompanying the feeding roller 202 as described above, the sheets are separated one by one. The increase/decrease in speed of the second motor 503 in S12 to S16 are all provided by self-start operation of the second motor 503.

In such control as described above, there are an idle time of 10 ms during which sheets are not returned to the sheet return direction and a halt time of 10 ms, during time from the start of the driving to the start of rotation in the sheet return direction of retard roller 203. However, in the case of such lengths of the idle time and the halt time, even if two or more sheets exist in the separation nip part, the second sheet onwards are returned to the separation nip part by the retard roller 203 before reaching the pull-off rollers 204. Consequently, it can be ensured that sheets are separated one by one.

As described above, in the present embodiment, when the driving of the separation part 37a is resumed after a temporary stop, if a sheet exists in the separation nip part, the retard roller 203 is rotated forward before driving the retard roller 203 to rotate in the sheet return direction in which the sheet is returned to the sheet container side. In other words, in the present embodiment, when the driving of the separation part 37a is resumed after a temporary stop, if a sheet exists in the separation nip part, the direction of rotation of the retard roller 203 is temporarily switched to the sheet feeding direction. Consequently, upon the driving being resumed after a temporary stop, the retard roller 203 can constantly be in a rotating state, enabling prevention of generation of a local recession in the retard roller 203.

There are some sheet feeding apparatuses in which a sheet existence/non-resistance detection sensor cannot be arranged in the vicinity of a separation nip part because of restrictions relating to, e.g., space. In such sheet feeding apparatuses, when a sheet feeding operation is resumed, whether or not a sheet exists in the separation nip part can be determined based on a result calculated from the sheet feed speed, the time from start of the sheet feeding operation to the halt of the sheet and the sheet size.

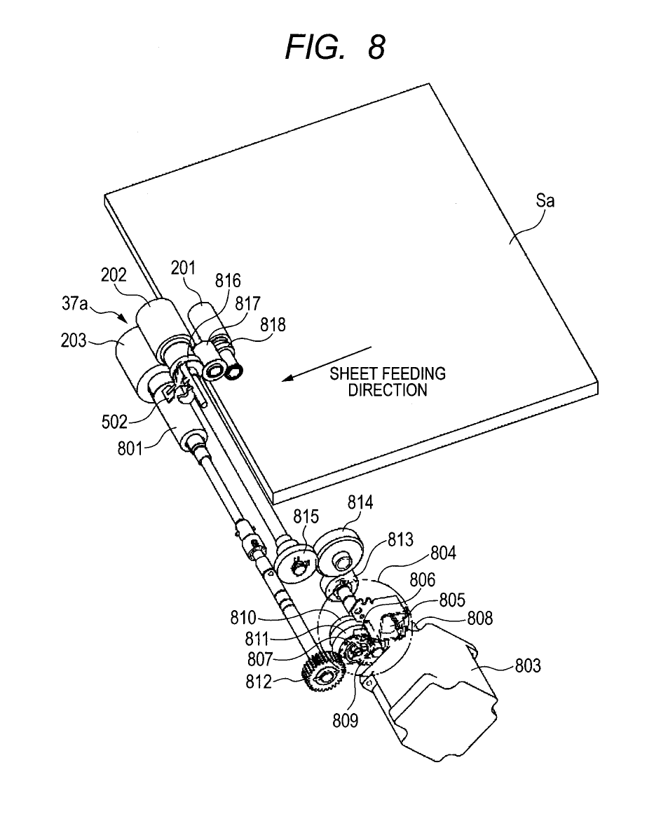

Next, a second embodiment of the present invention will be described. FIG. 8 is a diagram illustrating a driving system in a sheet feeding apparatus according to the present embodiment. In FIG. 8, reference numerals that are the same as those in FIG. 4 are components identical or corresponding to those in FIG. 4.

As illustrated in FIG. 8, a pickup roller 201 and a feeding roller 202 are connected via gears 816 to 818 and driven by a motor 803 via gears 808, 809, 813 to 815 to rotate in synchronization with each other. Also, a retard roller 203 is driven by a motor 803, which is a drive part, via gears 808 to 812.

Here, in the present embodiment, the retard roller 203 and the motor 803 are connected to a planetary gear clutch 804, which is a clutch that selectively transmits a driving force of the motor 803 to the retard roller 203. The driving force transmission connection via the planetary gear clutch 804 enables switching between a state in which the driving force of the motor 803 is transmitted to the retard roller 203 and a state in which the transmission of the driving force of the motor 803 is interrupted, by switching of the planetary gear clutch 804.

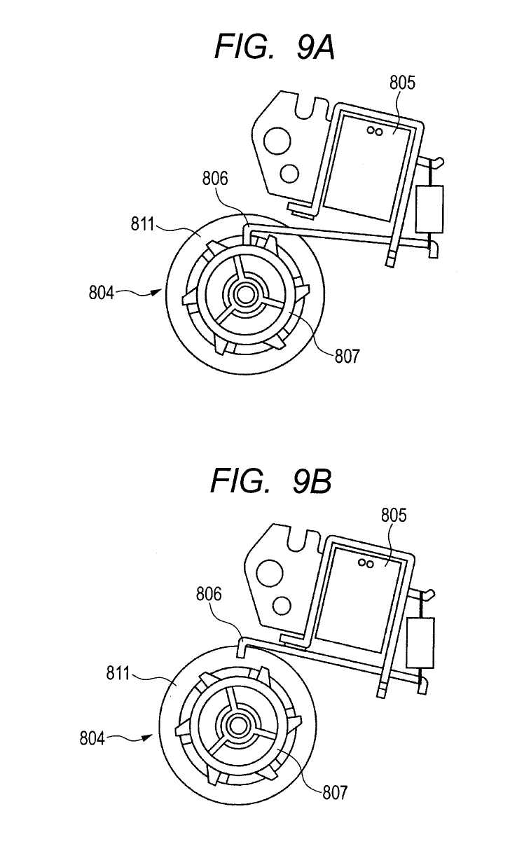

FIG. 9A illustrates a state in which the planetary gear clutch 804 is locked as a result of a solenoid 805 being in an off state. Here, when the solenoid 805 is off as described above, a lever 806 of the solenoid 805 engages with a sun gear 807, and consequently, two non-illustrated planetary gears existing inside the gear 810 cannot revolve, and the planetary gear clutch 804 enters a driving force transmission state. Consequently, the gear 811 rotates, thereby the driving force of the motor 803 being transmitted to the retard roller 203.

FIG. 9B illustrates a state in which the solenoid 805 is turned on, thereby the planetary gear clutch 804 being unlocked. Here, when the solenoid 805 is on, the lever 806 and the sun gear 807 are disengaged, resulting in the two non-illustrated planetary gears existing inside the gear 810 being able to revolve, and consequently, the planetary gear clutch 804 enters an idle state. Consequently, the gear 811 does not rotate, and the transmission of the driving force of the motor 803 through the driving force transmission path to the retard roller 203 is interrupted.

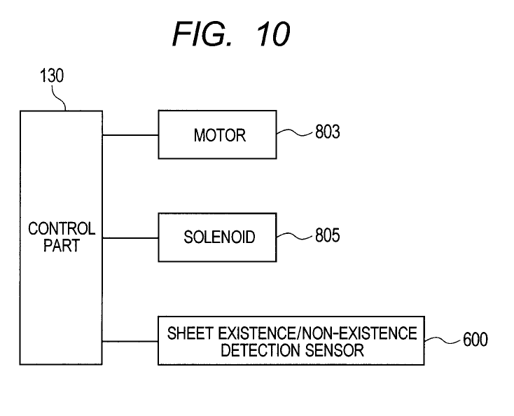

FIG. 10 is a block diagram for control of a sheet feeding apparatus using a retard roller separating system. As illustrated in FIG. 10, the motor 803, the solenoid 805 and a sheet existence/non-resistance detection sensor 600 are connected to the control part 130. Upon a signal representing that a sheet exists in a separation nip part being input from the sheet existence/non-resistance detection sensor 600, the control part 130 turns the solenoid 805 on for a predetermined period of time from a predetermined timing before the sheet feeding operation is resumed.

As described above, in the present embodiment, if the driving is halted in a state in which a sheet exists in the separation nip part, the solenoid 805 is turned on before the sheet feeding operation is resumed, to interrupt the transmission of the driving force of the motor 803 to the retard roller 203 through the driving force transmission path. Then, after the sheet feeding operation is resumed and the retard roller 203 rotates accompanying the feeding roller 202, the retard roller 203 is rotated in a sheet return direction. In other words, in the present embodiment, when the sheet feeding operation is resume, the transmission of the driving force of the motor 803 to the retard roller 203 is interrupted in advance, and subsequently, the motor 803 drives the retard roller 203 to rotate in the sheet return direction.

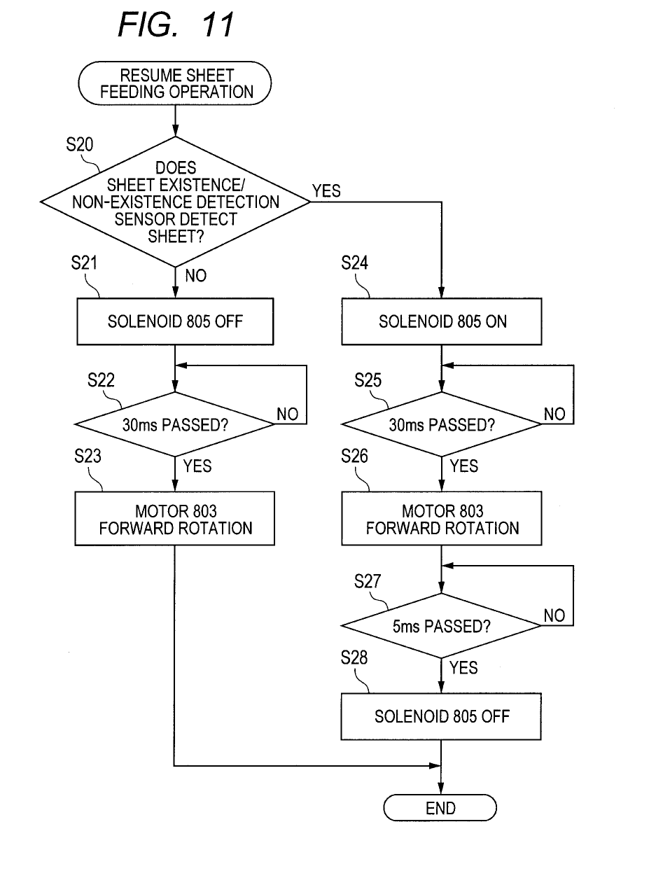

Next, sheet separation control in a sheet feeding apparatus according to the present embodiment will be described using the flowchart illustrated in FIG. 11. Here, it is assumed that a direction of rotation of the motor 803 when the pickup roller 201 and feeding roller 202 rotate in the sheet feeding direction and the retard roller 203 rotates in the sheet return direction is forward rotation.

The control part 130 determines whether or not a sheet exists in the separation nip part, by means of the sheet existence/non-resistance detection sensor 600, for example, 30 ms before a sheet feeding operation is resumed (S20). Then, if the sheet existence/non-resistance detection sensor 600 detects no sheet (N in S21), the solenoid 805 is kept off (S21). Consequently, as illustrated in FIG. 9A, the retard roller 203 and the motor 803 are connected via the planetary gear clutch 804 in terms of driving force transmission.

Next, after passage of 30 ms (Y in S22), the motor 803 is rotated forward to resume the sheet feeding operation. When the motor 803 rotates forward, the retard roller 203 rotates forward and the driving force of the motor 803 is transmitted to the retard roller 203 via the planetary gear clutch 804. However, even when the driving force of the motor 803 is transmitted to the retard roller 203 as described above, the retard roller 203 rotates accompanying the feeding roller 202. When sheets are transported to the separation nip part afterward as a result of the accompanying rotation, the sheets are separated one by one.

Meanwhile, if the sheet existence/non-resistance detection sensor 600 detects a sheet (Y in S20), the solenoid 805 is turned on (S24). Consequently, as illustrated in FIG. 9B, the planetary gear clutch 804 enters an idle state, and the transmission of the driving force of the motor 803 to the retard roller 203 through the driving force transmission path is interrupted. Subsequently, after passage of 30 ms (Y in S25), the motor 803 is rotated forward. Then, the forward rotation of the motor 803 makes the feeding roller 202 to temporarily rotate in the sheet feeding direction.

In this case, the forward rotation of the motor 803 is not transmitted to the retard roller 203, and thus, the retard roller 203 rotates accompanying the feeding roller 202 in the sheet feeding direction. As a result, the sheet existing in the separation nip part passes through the separation nip part. Here, as a result of making the retard roller 203 rotate accompanying the feeding roller 202 in the sheet feeding direction, that is, making the retard roller 203 to enter a rotating state, a following force F_{CS} becomes larger than a resistance force F_{avg} of the retard roller 203.

Next, after passage of 5 ms from start of the forward rotation of the motor 803 (Y in S27), the solenoid 805 is turned off (S28). As a result of the solenoid 805 being turned on during forward rotation of the motor 803 as described above, the planetary gear clutch 804 enters a driving force transmission state, and after passage of a response time of around 15 ms, the retard roller 203 is connected to the motor 803 in terms of driving force transmission. Consequently, the retard roller 203 is driven to rotate in the sheet return direction.

Here, when the forward rotation of the motor 803 is transmitted to the retard roller 203, the retard roller 203 is rotating in the sheet feeding direction, and thus, the following force F_{CS} becomes larger than the rolling resistance force F_{avg}. Accordingly, the retard roller 203 rotates accompanying the feeding roller 202. As a result of the motor 803 rotating forward rotation while the retard roller 203 rotating accompanying the feeding roller 202 as described above, sheets are transported to the separation nip part afterward, the sheets are separated one by one.

In such control, there is idle time of around 20 ms during time from the start of the driving to the start of rotation in the sheet return direction of the retard roller 203. However, even if two or more sheets exist in the separation nip part, in the case of such length of the idle time, the second sheet onwards are returned to the separation nip part by the retard roller 203 before reaching pull-off rollers 204. Consequently, it can be ensured that sheets are separated one by one.

As described above, in the present embodiment, when driving of a separation part 37a is resumed after a temporary stop, if a sheet exists in the separation nip part, the planetary gear clutch 804, which is a rotation direction switching part, is made to enter an idle state. Consequently, the retard roller 203 rotates accompanying the feeding roller 202 in the sheet feeding direction. Subsequently, the planetary gear clutch 804 is made to enter a driving force transmission state to drive the retard roller 203 to rotate in the sheet return direction in which the sheet is returned to the sheet container side.

As described above, in the present embodiment, when the driving of the separation part 37a is resumed after a temporary stop, first, using the planetary gear clutch 804, the retard roller 203 is made to temporarily enter a state in which the retard roller 203 rotates in association with the feeding roller 202 (following rotation state). Subsequently, the retard roller 203 is driven to rotate in the sheet return direction in which the sheet is returned to the sheet container side.

In other words, in the present embodiment, when the driving of the separation part 37a is resumed after a temporary stop, if a sheet exists in the separation nip part, the retard roller 203 is made to temporarily rotate in association with the feeding roller 202 before rotating in the sheet return direction. Consequently, when the driving is resumed after a temporary stop, the retard roller 203 can consistently be in a rotating state, enabling prevention of generation of a local recession in the retard roller 203.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-065998, filed Mar. 24, 2011, which is hereby incorporated by reference herein in its entirety.

What is claimed is:

1. A sheet feeding apparatus comprising:
a feeding roller that feeds a sheet from a sheet container;
a retard roller that is in pressure-contact with the feeding roller, is provided so as to be rotatable in a direction opposite to a sheet feeding direction in which the sheet is fed from the sheet container, and is capable of rotation following the feeding roller;
a detection part that detects whether or not a sheet exists in a separation nip part formed by the feeding roller and the retard roller;
a rotation direction switching part that temporarily rotates the retard roller in the sheet feeding direction; and
a control part that temporarily stops driving of the feeding roller after passage of a predetermined period of time from the sheet being fed out, and when the temporarily-stopped driving of the feeding roller is resumed, if the detection part determines that a sheet exists in the separation nip part, makes the rotation direction switching part temporarily rotate the retard roller in the sheet feeding direction.

2. A sheet feeding apparatus according to claim 1, wherein the rotation direction switching part is a drive part that is rotatably forward or reversely, and the control part controls the drive part to drive the retard roller to rotate in the sheet feeding direction or the opposite direction, and if the control part determines that a sheet exists in the separation nip part, the control part controls the drive part to temporarily rotate the retard roller in the sheet feeding direction.

3. A sheet feeding apparatus according to claim 1, further comprising a drive part that drives the retard roller to rotate in the opposite direction,
wherein the rotation direction switching part includes a clutch provided in a driving force transmission path between the retard roller and the drive part, and the control part controls the clutch to transmit a driving force of the drive part to the retard roller, and if the control part determines that a sheet exists in the separation nip part, the control part controls the clutch to halt the transmission of the driving force of the drive part to make the retard roller rotate following the feeding roller.

4. An image forming apparatus comprising:
a feeding roller that feeds a sheet from a sheet container;
a retard roller that is in pressure-contact with the feeding roller, is provided so as to be rotatable in a direction opposite to a sheet feeding direction in which the sheet is fed from the sheet container, and is capable of rotation following the feeding roller;
a detection part that detects whether or not a sheet exists in a separation nip part formed by the feeding roller and the retard roller;
a rotation direction switching part that temporarily rotates the retard roller in the sheet feeding direction;
a control part that temporarily stops driving of the feeding roller after passage of a predetermined period of time from the sheet being fed out, and when the temporarily-stopped driving of the feeding roller is resumed, if the detection part determines that a sheet exists in the separation nip part, makes the rotation direction switching part temporarily rotate the retard roller in the sheet feeding direction; and
an image forming part that forms an image on a sheet separated and fed by the feeding roller and the retard roller.

5. An image forming apparatus according to claim 4, wherein the rotation direction switching part is a drive part that is rotatable forward or reversely, and the control part controls the drive part to drive the retard roller to rotate in the sheet feeding direction or the opposite direction, and if the control part determines that a sheet exists in the separation nip part, the control part controls the drive part to temporarily rotate the retard roller in the sheet feeding direction.

6. An image forming apparatus according to claim 4, further comprising a drive part that drives the retard roller to rotate in the opposite direction,
wherein the rotation direction switching part includes a clutch provided in a driving force transmission path between the retard roller and the drive part, and the control part controls the clutch to transmit a driving force of the drive part to the retard roller, and if the control part determines that a sheet exists in the separation nip part, the control part controls the clutch to halt the transmission of the driving force of the drive part to make the retard roller rotate following the feeding roller.
